(19) United States
(12) Patent Application Publication
(10) Pub. No.: US 2024/0047778 A1
(43) Pub. Date: Feb. 8, 2024

(54) ORGANIC HEAT TRANSFER SYSTEM, METHOD, AND FLUID

(71) Applicant: The Lubrizol Corporation, Wickliffe, OH (US)

(72) Inventors: Anil Agiral, Pepper Pike, OH (US); Patrick E. Mosier, Bay Village, OH (US); Eugene Pashkovski, Moreland Hills, OH (US); Amy L. Short, Lakewood, OH (US)

(73) Assignee: The Lubrizol Corporation, Wickliffe, OH (US)

(21) Appl. No.: 18/266,630

(22) PCT Filed: Dec. 13, 2021
(86) PCT No.: PCT/US2021/063064

§ 371 Date: Jun. 12, 2023

Related U.S. Application Data
(60) Provisional application No. 63/125,210, filed on Dec. 14, 2020.

(51) Int. Cl. H01M 10/613; H01M 10/6567

(52) U.S. Cl. CPC H01M 10/613; H01M 10/6567; H01M 2220/20

(57) ABSTRACT

The disclosed technology relates to a dielectric oleaginous heat transfer system, method, and fluid comprising a) a non-conductive, non-aqueous and non-water miscible dielectric oleaginous fluid and b) at least one high molecular weight. In particular, the technology relates to a dielectric oleaginous heat transfer system, method, and fluid with low electrical conductivity, low shear viscosity, and low flammability, that provides temperature reduction in a heat transfer system, such as that for cooling a battery pack or a power system of an electric vehicle.

### BACKGROUND OF THE INVENTION

The disclosed technology relates to a heat transfer system and heat transfer method employing a dielectric oleaginous heat transfer fluid. In particular, the technology relates to a dielectric oleaginous heat transfer fluid with low electrical conductivity and low flammability that provides peak temperature reduction in a heat transfer system, such as that for cooling a battery pack or a power system of an electric vehicle.

The operation of a power source generates heat. A heat transfer system, in communication with the power source, regulates the generated heat, and ensures that the power source operates at an optimum temperature. The heat transfer system generally comprises a heat transfer fluid that facilitates absorbing and dissipating the heat from the power source. Heat transfer fluids, which generally consist of water and a glycol, can be expensive and are prone to freezing. Traditional heat transfer fluids can also exhibit extremely high conductivities, often in the range of 3000 micro-siemens per centimeter (μS/cm) or more. This high conductivity produces adverse effects on the heat transfer system by promoting corrosion of metal parts, and also in the case of power sources where the heat transfer system is exposed to an electrical current, such as in fuels cells or the like, the high conductivity can lead to short circuiting of the electrical current and to electrical shock.

Current battery pack designs include an integrated and isolated cooling system that routes coolant throughout the enclosure. When in good working order, the coolant from the cooling system does not come into contact with the electric potentials protected within. It does happen that sometimes a leak occurs and coolant enters into unintended parts of the enclosure. If the coolant is electrically conductive, it can bridge terminals having relatively large potential differences. That bridging may start an electrolysis process in which the coolant is electrolyzed and the coolant will begin to boil when enough energy is conducted into the electrolysis. This boiling can create the local thermal condition that can lead to the runaway thermal condition described above.

Oil based fluids have been identified as potential alternatives for heat transfer fluids in battery pack applications. Oil based fluids provide excellent heat transfer and can be used in direct contact with electrical components due to low electrical conductivity. However, oil based fluids have the drawback of increased flammability if the oil is aerosolized. It would be beneficial to have an dielectric oleaginous heat transfer fluid that has good fluid flow properties for cooling and decreased flammability.

### SUMMARY OF THE INVENTION

The present invention provides a system, method and fluid for cooling electrical componentry. In one embodiment, the present invention involves a dielectric oleaginous heat transfer fluid comprising a water-immiscible oil component and 0.001% to 1% by weight of a polymer additive component, wherein the polymer additive component comprises a polyolefin polymer having a number average molecular weight of at least about 20,000 as measured by gel permeation chromatography. In one embodiment, the present invention involves a dielectric oleaginous heat transfer fluid comprising a water-immiscible oil component and no more than 500 ppm of a polymer additive component, wherein the polymer additive component comprises a polyolefin polymer having a number average molecular weight of at least about 20,000 as measured by gel permeation chromatography. In another embodiment, the present invention involves a system and method wherein the dielectric oleaginous heat transfer fluid is in contact with electrical componentry. These embodiments will be described in more detail herein.

### DETAILED DESCRIPTION OF THE INVENTION

Various preferred features and embodiments will be described below by way of non-limiting illustration.

The disclosed technology provides, among other things, a dielectric oleaginous heat transfer fluid. The dielectric oleaginous heat transfer fluid comprises a) a nonconductive, non-aqueous and non-water miscible fluid and b) a polymer additive component. As used herein, the term “a,” as in “a” polymer additive, or “a” fluid, is not limited to just one of the stated elements, but is used to mean “at least one,” which includes one or more of the stated elements, as well as two or more, three or more and so on.

### Non-Conductive, Non-Aqueous, Non-Water Miscible Fluid

One component of the disclosed technology is a non-conductive, non-aqueous and non-water miscible fluid. This fluid may be selected from any of the base oils in Groups I-V of the American Petroleum Institute (API) Base Oil Interchangeability Guidelines (2011), namely

| | | Viscosity |
|---|---|---|
| Base Oil Category Sulfur (%) | Saturates (%) | Index |
| Group I | >0.03 and/or <90 | 80 to less |
| | | than 120 |
| Group II | ≤0.03 and ≥90 | 80 to less |
| | | than 120 |
| Group III | ≤0.03 and ≥90 | ≥120 |
| Group IV | All polyalphaolefins (PAOs) | |
| Group V | All others not included in | |
| | Groups I, II, III or IV | |

Groups I, II and III are mineral oil base stocks. Other generally recognized categories of base oils may be used, even if not officially identified by the API: Group II+, referring to materials of Group II having a viscosity index of 110-119 and lower volatility than other Group II oils; and Group III+, referring to materials of Group III having a viscosity index greater than or equal to 130.

While many non-water miscible oleaginous fluids may work in the method and/or system of the present invention, in one embodiment of the invention, the non-water miscible oleaginous fluid may be selected from isoparaffins.

Isoparaffins (or isoparaffinic oils) are saturated hydrocarbon compounds containing at least one hydrocarbyl branch, sufficient to provide fluidity to both very low and high temperatures. Isoparaffins of the invention may include natural and synthetic oils, oil derived from hydrocracking, hydrogenation, and hydrofinishing of refined oils, re-refined oils or mixtures thereof.

Synthetic oleaginous fluids may be produced by isomerization of predominantly linear hydrocarbons to produce branched hydrocarbons. Linear hydrocarbons may be naturally sourced, synthetically prepared, or derived from Fischer-Tropsch reactions or similar processes. Isoparaffins may be derived from hydro-isomerized wax and typically may be hydro-isomerised Fischer-Tropsch hydrocarbons or waxes. In one embodiment oils may be prepared by a Fischer-Tropsch gas-to-liquid synthetic procedure as well as other gas-to-liquid oils.

Suitable isoparaffins may also be obtained from natural, renewable, sources. Natural (or bio-derived) oils refer to materials derived from a renewable biological resource, organism, or entity, distinct from materials derived from petroleum or equivalent raw materials. Natural sources of hydrocarbon oil include fatty acid triglycerides, hydrolyzed or partially hydrolyzed triglycerides, or transesterified triglyceride esters, such as fatty acid methyl ester (or FAME). Suitable triglycerides include, but are not limited to, palm oil, soybean oil, sunflower oil, rapeseed oil, olive oil, linseed oil, and related materials. Other sources of triglycerides include, but are not limited to algae, animal tallow, and zooplankton. Linear and branched hydrocarbons may be rendered or extracted from vegetable oils and hydro-refined and/or hydro-isomerized in a manner similar to synthetic oils to produce isoparaffins.

Another class of isoparaffinic oils includes polyolefins. Polyolefins are well known in the art. In one embodiment, the polyolefin may be derivable (or derived) from olefins with 2 to 24 carbon atoms. By derivable or derived it is meant the polyolefin is polymerized from the starting polymerizable olefin monomers having the noted number of carbon atoms or mixtures thereof. In embodiments, the polyolefin may be derivable (or derived) from olefins with 3 to 24 carbon atoms. In some embodiments, the polyolefin may be derivable (or derived) from olefins with 4 to 24 carbon atoms. In further embodiments, the polyolefin may be derivable (or derived) from olefins with 5 to 20 carbon atoms. In still further embodiments, the polyolefin may be derivable (or derived) from olefins with 6 to 18 carbon atoms. In still further embodiments, the polyolefin may be derivable (or derived) from olefins with 8 to 14 carbon atoms. In alternate embodiments, the polyolefin may be derivable (or derived) from olefins with 8 to 12 carbon atoms.

Often the polymerizable olefin monomers comprise one or more of ethylene, propylene, isobutene, 1-butene, isoprene, 1,3-butadiene, or mixtures thereof. An example of a useful polyolefin is polyisobutylene. Polymerizable olefins may also include certain dienes, including 1,3-dienes, such as 1,3-butadiene and isoprene and higher olefins that may be directly derived from such dienes such as terpenes, for example, farnesene or partially hydrogenated terpenes.

Polyolefins also include poly-α-olefins derivable (or derived) from α-olefins. The α-olefins may be linear or branched or mixtures thereof. Examples include mono-olefins such as propylene, 1-butene, isobutene, 1-pentene, 1-hexene, 1-heptene, 1-octene, 1-nonene, 1-decene, etc. Other examples of α-olefins include 1-decene, 1-undecene, 1-dodecene, 1-tridecene, 1-tetradecene, 1-pentadecene, 1-hexadecene, 1-heptadecene 1-octadecene, and mixtures thereof. An example of a useful α-olefin is 1-dodecene. An example of a useful poly-α-olefin is polydecene.

The polyolefin may also be a copolymer of at least two different olefins, also known as an olefin copolymer (OCP). These copolymers are preferably copolymers of α-olefins having from 2 to about 28 carbon atoms, preferably copolymers of ethylene and at least one α-olefin having from 3 to about 28 carbon atoms, typically of the formula CH₂═CHR₁ wherein R₁ is a straight chain or branched chain alkyl radical comprising 1 to 26 carbon atoms. Preferably R₁ in the above formula can be an alkyl of from 1 to 8 carbon atoms, and more preferably can be an alkyl of from 1 to 2 carbon atoms. Preferably, the polymer of olefins is an ethylene-propylene copolymer.

Where the olefin copolymer includes ethylene, the ethylene content is preferably in the range of 20 to 80 percent by weight, and more preferably 30 to 70 percent by weight. When propylene and/or 1-butene are employed as comonomer(s) with ethylene, the ethylene content of such copolymers is most preferably 45 to 65 percent, although higher or lower ethylene contents may be present.

In one embodiment, the oleaginous fluid may be substantially free of ethylene and polymers thereof. The composition may be completely free of ethylene and polymers thereof. By substantially free, it is meant that the composition contains less than 50 ppm, or less than 30 ppm, or even less than 10 ppm or 5 ppm, or even less than 1 ppm of the given material.

In an embodiment of the invention, the oleaginous fluid may be substantially free of propylene and polymers thereof. In another embodiment, the oleaginous fluid may be completely free of propylene and polymers thereof. The polyolefin polymers prepared from the aforementioned olefin monomers can have a number average molecular weight of from 140 to 5000. The polyolefin polymers prepared from the aforementioned olefin monomers can also have a number average molecular weight of from 200 to 4750. The polyolefin polymers prepared from the aforementioned olefin monomers can also have a number average molecular weight of from 250 to 4500. The polyolefin polymers prepared from the aforementioned olefin monomers can also have a number average molecular weight of from 500 to 4500. The polyolefin polymers prepared from the aforementioned olefin monomers can also have a number average molecular weight of from 750 to 4000 as measured by gel permeation chromatography (GPC) with polystyrene standard. GPC with a polystyrene standard is the standard method employed for all Mn quoted in this reference.

Mixtures of mineral oil and synthetic oils, e.g., polyalphaolefin oils and/or polyester oils, may be used.

In another embodiment of the present invention, the oleaginous fluid can be a saturated hydrocarbon compound containing 8 carbon atoms up to a maximum of 50 carbon atoms and having at least one hydrocarbyl branch containing at least one carbon atom. In one embodiment, the saturated hydrocarbon compound can have at least 10 or at least 12 carbon atoms. In one embodiment, the saturated hydrocarbon compound can contain 14 to 34 carbon atoms with the proviso that the longest continuous chain of carbon atoms is no more than 24 carbons in length.

In some embodiments, the oleaginous fluid will have a longest continuous chain of carbon atoms of no more than 24 carbons in length.

In some embodiments, the saturated hydrocarbon compound can be a branched acyclic compound with a molecular weight of 140 g/mol to 550 g/mol as measured by size exclusion chromatography (SEC also called gel permeation chromatography or GPC), liquid chromatography, gas chromatography, mass spectrometry, NMR, or combinations thereof, or from 160 g/mol to 480 g/mol.

Mineral oils often contain cyclic structures, i.e. aromatics or cycloparaffins also called naphthenes. In one embodiment, the isoparaffin comprises a saturated hydrocarbon compound free of or substantially free of cyclic structures. By substantially free, it is meant there is less than 1 mol % of cyclic structures in the mineral oil, or less than mol %, or less than 0.5 mol %, or even less than 0.25 mol %. In some embodiments, the mineral oil is completely free of cyclic structures.

Group IV hydrocarbon base oils (also known as polyalphaolefins or PAO) are known in the art and are prepared by oligomerization or polymerization of linear alpha olefins (typically 1-decene, 1octene, 1-dodecene, or combinations thereof). PAOs are characteristically water white oils with superior low temperature viscosity properties (as measured, as well as high viscosity index. Typical PAOs suitable for use as thermal fluids include PAO-2, PAO-4, PAO-5 and PAO-6, i.e. approximately 2, 4, 5 and 6 m2/s respectively, and mixtures thereof.

It has also been found that certain ester oils and ether oils as well provide particularly improved heat transfer when used as the dielectric oleaginous heat transfer fluids in the disclosed method.

Esters suitable for use as dielectric oleaginous heat transfer fluids include esters of monocarboxylic acids with monohydric alcohols; di-esters of diols with monocarboxylic acids and di-esters of dicarboxylic acids with monohydric alcohols; polyol esters of monocarboxylic acids and polyesters of monohydric alcohols with polycarboxylic acids; and mixtures thereof. Esters may be broadly grouped into two categories: synthetic and natural.

Synthetic esters suitable as the dielectric oleaginous heat transfer fluids may comprise esters of monocarboxylic acid (such as neopentanoic acid, 2-ethylhexanoic acid) and dicarboxylic acids (e.g., phthalic acid, succinic acid, alkyl succinic acids and alkenyl succinic acids, maleic acid, azelaic acid, suberic acid, sebacic acid, fumaric acid, adipic acid, linoleic acid dimer, malonic acid, alkyl malonic acids, and alkenyl malonic acids) with any of variety of monohydric alcohols (e.g., butyl alcohol, pentyl alcohol, neopentyl alcohol, hexyl alcohol, octyl alcohol, iso-octyl alcohol, nonyl alcohol, decyl alcohol, isodecyl alcohol, dodecyl alcohol, tetradecyl alcohol, hexadecyl alcohol, 2-ethylhexyl alcohol, ethylene glycol, diethylene glycol monoether, and propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid. Other synthetic esters include those made from C₅ to C₁₂ monocarboxylic acids and polyols and polyol ethers such as neopentyl glycol, trimethylolpropane, pentaerythritol, dipentaerythritol, and tripentaerythritol. Esters can also be monoesters of mono-carboxylic acids and monohydric alcohols.

Natural (or bio-derived) esters refer to materials derived from a renewable biological resource, organism, or entity, distinct from materials derived from petroleum or equivalent raw materials. Natural esters suitable as the dielectric oleaginous heat transfer fluids include fatty acid triglycerides, hydrolyzed or partially hydrolyzed triglycerides, or transesterified triglyceride esters, such as fatty acid methyl ester (or FAME), or esters derived from metathesis of unsaturated fatty acids. Suitable triglycerides include, but are not limited to, palm oil, soybean oil, sunflower oil, rapeseed oil, olive oil, linseed oil, and related materials. Other sources of triglycerides include, but are not limited to, algae, animal tallow, and zooplankton. Other examples of natural bioderived esters include oligomers of fatty acids, such as those commercially available under the trademark Estolides™ from Biosynthetic Technologies.

Other suitable oleaginous fluids include alkylated aromatic oils (such as alkylated naphthalene), low viscosity naphthenic mineral oils, and (poly)ether oils. Alkylene oxide polymers and interpolymers and derivatives thereof, and those where terminal hydroxyl groups have been modified by, for example, esterification or etherification, constitute other classes of known synthetic lubricating oils that can be used. Examples of (poly)ether base oils include diethylene glycol dibutyl ether.

### Polymer Additive

The composition of the invention contains a high molecular weight polymer component. The high molecular weight polymer component may include one or more polymers having a number average molecular weight of at least about 20,000 Daltons. In one embodiment, a polymer useful as or in the polymer additive component may be prepared by polymerizing an alpha-olefin monomer, or mixtures of alpha-olefin monomers, or mixtures comprising ethylene and at least one C3 to C28 alpha-olefin monomer, in the presence of a catalyst system comprising at least one metallocene (e.g., a cyclopentadienyl-transition metal compound) and an alumoxane compound.

Suitable polymers of the olefin polymer variety include ethylene propylene copolymers, ethylene-propylene-alpha olefin terpolymers, ethylene-alpha olefin copolymers, ethylene propylene copolymers further containing a non-conjugated diene, and isobutylene/conjugated diene copolymers, each of which may be subsequently supplied with grafted functionality.

Ethylene-propylene or higher alpha monoolefin copolymers may consist of to 80 mole % ethylene and 20 to 85 mole % propylene or higher monoolefin, in some embodiments, the mole ratios being 30 to 80 mole % ethylene and 20 to 70 mole % of at least one C3 to C10 alpha monoolefin, for example, 50 to 80 mole % ethylene and 20 to mole % propylene. Terpolymer variations of the foregoing polymers may contain up to mole % of a non-conjugated diene or triene.

In these embodiments, the polymer substrate, such as the ethylene copolymer or terpolymer, can be an oil-soluble, substantially linear, rubbery material. Also, in certain embodiments the polymer can be in forms other than substantially linear, that is, it can be a branched polymer or a star polymer. The polymer can also be a random copolymer or a block copolymer, including di-blocks and higher blocks, including tapered blocks and a variety of other structures. These types of polymer structures are known in the art and their preparation is within the abilities of the person skilled in the art.

Other olefinic monomers used to prepare polymers for the polymer additive component of the present invention may also include polymerizable olefins also include certain dienes, such as 1,3-dienes, such as 1,3-butadiene and isoprene and higher olefins that may be directly derived from dienes such as terpenes, for example, farnesene or partially hydrogeneated terpenes.

The terms polymer and copolymer are used generically to encompass ethylene and/or higher alpha monoolefin polymers, copolymers, terpolymers or interpolymers. These materials may contain minor amounts of other olefinic monomers so long as their basic characteristics are not materially changed.

Another useful class of polymers is that constituted by polymers prepared by cationic polymerization of, e.g., isobutene or styrene. Common polymers from this class include polyisobutenes obtained by polymerization of a C4 refinery stream having a butene content of 35 to 75 mass %, and an isobutene content of 30 to 60 mass %, in the presence of a Lewis acid catalyst such as aluminum trichloride or boron trifluoride, aluminum trichloride being suitable. Suitable sources of monomer for making poly-n-butenes are petroleum feedstreams such as raffinate II. These feedstocks are disclosed in the art such as in U.S. Pat. No. 4,952,739. Polyisobutylene is a suitable polymer for the present invention because it is readily available by cationic polymerization from butene streams (e.g., using AlCl3 or BF3 catalysts).

It is known that polyisobutylene can be prepared by cationic polymerization with the aid of boron halides, in particular boron trifluoride (E.P.-A 206 756, U.S. Pat. No. 4,316,973, GB-A 525 542 and GB-A 828 367). The polymerization of the isobutylene can be controlled so that polyisobutylenes having number average molecular weights (Mn) far higher than 1,000,000 can be obtained.

In one embodiment the olefin polymer is a copolymer of olefins with 4 or more carbon atoms. In one embodiment, the olefin polymer (polyolefin) comprises 50 to 100% by weight of units derived from at least one olefin monomer having four or more carbon atoms. In typical embodiments the olefins may be unsaturated aliphatic hydrocarbons such as butene, isobutylene (or isobutene), butadiene, isoprene, or combinations thereof.

The polyolefin polymer of the present invention may have a number average molecular weight (by gel permeation chromatography, polystyrene standard) of 20,000 to 10,000,000; 50,000 to 2,000,000, 100,000 to 1,500,000; or 200,000 to 1,000,000. In other embodiments the olefin polymer is polyisobutylene with number average molecular weight of at least 50,000, at least 100,000, or at least 250,000 up to 850,000, 600,000, or 500,000. Specific ranges include 250,000 to 750,000 or 250,000 to 500,000. The units for number average molecular weights described herein are Daltons.

The polymer additive component can be present on a weight basis in the dielectric oleaginous fluid composition of the present invention at 0.001 to 1%, or 0.003 to 0.8%, or 0.005 to 0.5%, or 0.01 to 0.1%, or 0.02% to 0.05%, for example 0.003% to 0.1% or even 0.003% to 0.01%. In another embodiment, the polymer additive component can be present in the dielectric oleaginous heat transfer fluid at concentrations of no more than 1000 ppm (parts per million), or no more than 800 ppm, or no more than 500 ppm, or no more than 300 ppm, or no more than 100 ppm, or 10 ppm to 50 ppm, or even 20 to 40 ppm. The concentration of the polymer in the dielectric oleaginous fluid composition is measured on an oil free basis.

The polymer additive component used in the present invention may consist or comprise of the polyolefin polymers described herein. In one embodiment, the polymer component may be substantially free of other polymer components not described herein. For example, the polyolefins and polyisobutylene polymers useful as the polymer additive component of the present invention may contain up to 5 mol % (less than 3%, less than 2%, less than 1%) of a vinylic, non-olefinic monomer that will copolymerize with the olefin. This may include vinylic monomers such as styrene or other non-olefinic monomers such as acrylates.

### Dielectric Oleaginous Fluid

The exact formulation of the dielectric oleaginous fluid depends on the systems into which the dispersions will be employed, and the desired properties needed for that system. For instance, the thermal conductivity, viscosity, flash point, and dielectric properties of the dispersion will be different if the fluid will be employed to cool a battery pack in an automobile versus cooling of a computer server farm.

The dielectric oleaginous fluid can be formulated by first choosing at least one non-conductive, non-aqueous and non-water miscible fluid having the desired dielectric properties, flash point and viscosity for the chosen application. For fluids to be effective as cooling thermal fluids, the shear viscosity of the fluid must be fairly low. In the present invention, the inventors have discovered that the addition of small amounts of high molecular weight polymer additives will allow the fluid to maintain the low viscosity necessary for effective cooling but will provide an unexpected increase in extensional viscosity. The increase in extensional viscosity increases the droplet size of the fluid in the event that the oleaginous fluid is sprayed from or aerosolized. Such increased droplet size reduces the flammability of the sprayed fluid.

To achieve the unexpected benefits of the present invention, at least one polymer additive can be chosen to provide the desired viscosity properties to the fluid. The polymer additive is selected and added to the fluid in amounts so as to increase the extensional viscosity of the fluid without appreciable or significant increase in the shear viscosity of the unadditised fluid. In other words, the polymer additive is selected and is added in amounts so that the shear viscosity of the non-water miscible fluid without polymer additive and with polymer additive does not change by more than 5%.

In one embodiment, the desired concentration of the polymer additive may be determined by the intrinsic viscosity of the polymer. For some polymer additives described herein the intrinsic viscosity can be found from the Mark-Houwink equation [η]=KM_{w}^{α}. The constants in this equation can be found experimentally by measuring intrinsic viscosity of polymers with different molar mass or using GPC with viscosity and multiangle light scattering detector. Alternatively, the parameters in the Mark-Houwink equation can be found in a polymer database or a polymer handbook (e.g http://polymerdata-base.com/polymer%20physics/MH%20Table.html, ISBN: 978-0-471-47936-9). The value of exponent alpha varies between 0.5 and 0.8 depending on the solvent quality being lower for solvent with lower quality. The parameter K depends on polymer molecular structure and solvent used and varies between 10,000-80,000 ml/g.

Once the at least one non-conductive, non-aqueous and non-water miscible fluid and the polymer additive component have been selected, the dielectric oleaginous fluid of the present invention can then be prepared according to standard techniques known in the art of combining polymer additives with oils. For example, the dielectric oleaginous fluid of the present invention may be prepared by simple mixture of the polymer additive into the non-conductive, non-aqueous and non-water miscible fluid.

Dielectric constant (also called relative permittivity) is an important feature of a heat transfer fluid for an immersion cooling system. To avoid issues with electrical current leakage, the dielectric oleaginous fluid can have a dielectric constant of 10.0 or lower as measured according to ASTM D924. The dielectric constant of the dielectric oleaginous fluid can also be 7.5 or lower as measured according to ASTM D924. The dielectric constant of the dielectric oleaginous fluid herein can also be 5 or lower as measured according to ASTM D924. The dielectric constant of the dielectric oleaginous fluid can also be 4.0 or lower as measured according to ASTM D924.

The dielectric oleaginous fluid can also have a kinematic viscosity measured at 100° C. of at least 0.7 cSt, or at least 0.9 cSt, or at least 1.1 cSt, or from 0.7 to 7.0 cSt, or from 0.9 to 6.5 cSt, or even from 1.1 to 6.0 cSt as measured according to ASTM D445_100. For a given chemical family and pump power, higher viscosity fluids have lower hydromechanical efficiency due to a higher resistance to flow.

The dielectric oleaginous fluid may have a dynamic viscosity. It is understood that kinematic viscosity and dynamic viscosity are related. The dielectric oleaginous fluid of the present invention may have a dynamic viscosity of from 1 mPa*s to 10 mPa*s, or even from 1.7 mPa to 5 mPa*s. Dynamic viscosity can be measured using an ARES G2 rheometer (TA Instruments) using double wall concentric cylinders geometry at shear rates 100-500 s¹ at 25° C.

Often heat transfer fluids need to flow freely at very low temperatures. In one embodiment the dielectric oleaginous fluid can have a pour point of at least −50° C., or at least −40° C., or at least −30° C. as measured according to ASTM D5985. In one embodiment, the dielectric oleaginous fluid can have an absolute viscosity of no more than 900 cP at −30° C., or no more than 500 cP at −30° C., or no more than 100 cP at −30° C. as measured according to ASTM D2983.

The dielectric oleaginous fluid can have a flash point of at least 50° C. as measured according to ASTM D56, or at least 60° C., or at least 75° C., or at least 100° C.

### Method of Cooling

The disclosed technology provides a method of cooling electrical componentry by providing a dielectric oleaginous fluid as described herein and contacting electrical componentry with the fluid and operating the electrical componentry. In one example, the contacting of the electrical componentry may be via a bath comprising the dielectric oleaginous fluid.

Electrical componentry includes any electronics that utilize power and generate thermal energy that must be dissipated to prevent the electronics from overheating. Examples include aircraft electronics, computer electronics such as microprocessors, uninterruptable power supplies (UPSs), power electronics (such as IGBTs, SCRs, thyristers, capacitors, diodes, transistors, rectifiers and the like), and the like. Further examples include invertors, DC to DC convertors, chargers, phase change invertors, electric motors, electric motor controllers, and DC to AC invertors.

While several examples of electrical componentry have been provided, the heat transfer fluid may be employed in any assembly or for any electrical componentry to provide an improved heat transfer fluid with cold temperature performance without significantly increasing the electrical conductivity and potential flammability of the mixture.

The method will be particularly useful in the transfer of heat from a battery systems, such as those in an electric vehicle such as an electric car, truck or even electrified mass transit vehicle, like a train or tram. The main piece of electrical componentry in electrified transportation is often battery modules, which may encompass one or more battery cell stacked relative to one another to construct the battery module. Heat may be generated by each battery cell during charging and discharging operations, or transferred into the battery cells during key-off conditions of the electrified vehicle as a result of relatively extreme (i.e., hot) ambient conditions. The battery module will therefore include a heat transfer system for thermally managing the battery modules over a full range of ambient and/or operating conditions. In fact, operation of battery modules can occur during the use and draining of the power therefrom, such as in the operation of the battery module, or during the charging of the battery module. With regard to charging, the use of the heat transfer fluid can allow the charging of the battery module to at least 75% of the total battery capacity restored in a time period of less than 15 minutes.

Similarly, electrical componentry in electrified transportation can include fuel cells, solar cells, solar panels, photovoltaic cells and the like that require cooling by the heat transfer fluid. Such electrified transportation may also include traditional internal combustion engines as, for example, in a hybrid vehicle.

Electrified transportation may also include electric motors as the electrical componentry. Electric motors may be employed anywhere along the driveline of a vehide to operate, for example, transmissions, axles and differentials. Such electric motors can be cooled by a heat transfer system employing the heat transfer fluid.

The method can include providing a heat transfer system containing electrical componentry requiring cooling. The heat transfer system will include, among other things, a bath in which the electrical componentry may be situated a manner that allows the electrical componentry to be in direct fluid communication with the dielectric oleaginous fluid. The bath will be in fluid communication with a heat transfer fluid reservoir containing the dielectric oleaginous fluid and a heat exchanger.

The electrical componentry may be operated along with operating the heat transfer system. The heat transfer system may be operated, for example, by circulating the dielectric oleaginous fluid through the heat transfer system.

For example, the heat transfer system may include means to pump cooled dielectric oleaginous fluid from the heat transfer fluid reservoir into the bath, and to pump heated dielectric oleaginous fluid out of the bath through the heat exchanger and back into the heat transfer fluid reservoir. In this manner, while the electrically componentry are operated, the heat transfer system may also be operated to provide cooled dielectric oleaginous fluid to the electrical componentry to absorb heat generated by the electrical componentry, and to remove dielectric oleaginous fluid that has been heated by the electrical componentry to be sent to the heat exchanger for cooling and recirculation back into the heat transfer fluid reservoir.

A thermal management system as disclosed herein may remove heat at a rate that allows for rapid charging of a battery. The target for high speed charging includes 120-600 kW. Given a 95% efficiency in the charge, the heat transfer fluid would need to remove up to 30 kW in a time of 10 to 60 minutes.

Various embodiments of the compositions disclosed herein may optionally comprise one or more additional performance additives. These additional performance additives may include one or more flame retardants, smoke suppressants, antioxidants, combustion suppressants, metal deactivators, flow additives, corrosion inhibitors, foam inhibitors, demulsifiers, pour point depressants, seal swelling agents, and any combination or mixture thereof. Typically, fully-formulated heat transfer fluids may contain one or more of these performance additives, and often a package of multiple performance additives. In one embodiment, one or more additional additives may be present in the dielectric oleaginous fluid at 0.01 weight percent up to 3 weight percent, or 0.05 weight percent up to 1.5 weight percent, or 0.1 weight percent up to 1.0 weight percent.

As used herein, the term “hydrocarbyl” is used in its ordinary sense, which is well-known to those skilled in the art. Specifically, it refers to a group having a carbon atom directly attached to the remainder of the molecule and having predominantly hydrocarbon character. Examples of hydrocarbyl groups include:
hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);
substituted hydrocarbon substituents, that is, substituents containing nonhydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);
hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

The invention herein is useful for cooling electrical componentry during operation, which may be better understood with reference to the following examples.

### Examples

A series of heat transfer fluids are prepared by first selecting a series of non-conductive, non-aqueous and non-water miscible fluids. The fluids range from simple isoparaffinic hydrocarbons to organic ester and ether compounds. The non-conducting, non-aqueous and non-water miscible fluids are listed in Table 1.

TABLE 1
Nonaqueous Fluids

| | | | | Thermal |
|---|---|---|---|---|
| | | KV¹ | T | Conductivity² |
| Ex. | Base Fluid | (m²/s) | (° C.) | (W/(m*K)) |
| F1 | Isodecyl Neopentanoate | 4.30 | 25.0 | 0.117 |
| F2 | Isoparaffin A | 3.60 | 20.0 | 0.110 |
| F3 | Diisooctyl adipate | 14.30 | 20.0 | 0.140 |
| F4 | Isoparaffin B | 5.70 | 20.0 | 0.110 |
| F5 | Thermal fluid blend A³ | 2.00 | 37.0 | 0.136 |
| F6 | Polyalphaolefin A | 5.05 | 25.0 | 0.14 |
| F7 | Polyalphaolefin B | 24.75 | | |
| F8 | Thermal fluid blend B4 | | | n/d |

¹Kinematic Viscosity at temperature (T) (ASTM D445_25)
²Thermal conductivity measured according to ASTM D7896
³45 wt % Isoparaffin B, 38 wt % dihexyl ether, 17 wt % n-dodecane
4Blend of Polyalphaolefin A (77 wt %), 2-ethylhexylcaprylate (10 wt %), dioctyl ether (10 wt %), and di(n-hexyl) ether (3 wt %)
5Measured at 40° C.

A series of polymer additives are selected as set forth in Table 2.

TABLE 2
Polymer Additives

| Poly- | | M_{w} | |
|---|---|---|---|
| mer | Chemical Type | (kDa) | Mn (kDa) |
| P1 | Ethylene-propylene copolymer (EP) | 140 | 60 |
| P2 | EP | 180 | 90 |
| P3 | EP | 250 | 125 |
| P4 | Functionalized EP (F-EP) | 140 | 60 |
| P5 | F-EP | 180 | 90 |
| P6 | F-EP | 250 | 125 |
| P7 | Polyisobutylene (PIB) | 500 | 200 |
| P8 | PIB | 900 | 300 |
| PS | PIB | 1,000 | 1,000 |
| P10 | PIB | 2,000 | 1,500 |

The impact of addition of polymeric additives to the thermal fluids of the invention is summarized below in Tables 3 and 4. Fluids were treated with polymers of the invention and the fluids were evaluated for changes in dynamic viscosity, extensional viscosity and time to fluid capillary break.

TABLE 3
Thermal Fluids

| | | | | | Max. | Fluid | |
|---|---|---|---|---|---|---|---|
| | | | Polymer | Dynamic | Apprent | Capillary | Thermal |
| | Base | | conc | Viscosity | Ext. Vis | Break Time | Conductivity |
| Examples | Fluid | Polymer | (ppm) | (mPa · s)¹ | (mPa · s)² | (ms)³ | (W/(m*K))⁴ |
| EX1 | F2 | — | 0 | 3.08 | 110 | 0.8 | 0.098 |
| EX2 | F2 | P9 | 30 | 2.94 | 4400 | 6.2 | 0.109 |
| EX3 | F4 | — | 0 | 4.55 | 115 | 0.75 | 0.110 |
| EX4 | F4 | P9 | 30 | 4.58 | 6600 | 8.76 | 0.112 |
| EX5 | F1 | — | 0 | 3.65 | 120 | 1.2 | 0.117 |
| EX6 | F1 | P9 | 30 | 3.7 | 5400 | 6.76 | 0.115 |
| EX7 | F5 | — | 0 | 1.88 | 110 | 1.19 | 0.125 |
| EX8 | F5 | P9 | 30 | 1.89 | 2720 | 4.28 | 0.125 |

¹Determined using ARES G2 rheometer (TA Instruments) using double wall concentric cylinders geometry at shear rates 100-500 s¹ (at 25° C.).
²The extensional viscosity was determined using Capillary breakup Extensional Rheometer (CABER1, Thermo-Haake) equipped with ultrafast video-camera (Fastcam F4, Photron, Inc.). The fluid is placed between 2 flat 4-mm diameter plates separated by the initial gap h 0 = 1.5 mm. When the gap is slowly increases with the velocity ~3 mm/s, the fluid bridge become unstable and the fluid bridge breaks. The capillary breakup occurs with some delay due to resistance of fluids to break. This resistance is due to shear and extensional viscosity. Each experimental test was repeated at least five times in order to corroborate reproducibility. The diameter of the filaments is being measured using digital imaging. A specially designed objective with x10 lens provided resolution of 1.9 micron/pixel. For calibration, a standard set of wires from Thermo-Haake (0.02, 0.03, 0.06, 0.12, 0.25, 0.50 and 1 mm) was used
³The capillary break time was determined from the time dependence of filament mid-diameter (i.e. where the diameter is close to zero) from at least 3 measurements For a series of images recorded with frame rates typically from 10,000 to 30,000 frames per second, the mid-filament diameter was measured using specially designed image analysis software (Edgehog, developed in Prof. C H. Clasen lab, KU Leuven, Belgium).
⁴Thermal conductivity measured according to ASTM D7896 at 25° C.

TABLE 4
Thermal Fluids

| | | | | | Max. | Fluid | |
|---|---|---|---|---|---|---|---|
| | | | Polymer | Kinematic | Apparent | Capillary | Thermal |
| | Base | | conc | Viscosity | Ext. Vis | Break Time | Conductivity |
| Examples | Fluid | Polymer | (ppm) | (m²/s)¹ | (mPa · s)² | (ms)³ | (W/(m*K))⁴ |
| EX9 | F6 | P9 | 30 | 5.0 | 3000 | 3.0 | 0.136 |
| EX10 | F7 | P9 | 30 | 24.6 | 8000 | 13.2 | 0.153 |
| EX115 | F8 | — | — | 4.26 | 150 | 0.98 | |
| EX125 | F8 | P9 | 40 | 4.28 | 2100 | 3.45 | 0.137 |

¹Kinematic viscosity at 40° C. (ASTM D445)
²The extensional viscosity was determined using Capillary breakup Extensional Rheometer (CABER1, Thermo-Haake) equipped with ultrafast video-camera (Fastcam F4, Photron, Inc.). The fluid is placed between 2 flat 4-mm diameter plates separated by the initial gap h 0 = 1.5 mm. When the gap is slowly increases with the velocity ~3 mm/s, the fluid bridge become unstable and the fluid bridge breaks. The capillary breakup occurs with some delay due to resistance of fluids to break. This resistance is due to shear and extensional viscosity. Each experimental test was repeated at least five times in order to corroborate reproducibility. The diameter of the filaments is being measured using digital imaging. A specially designed objective with x10 lens provided resolution of 1.9 micron/pixel. For calibration, a standard set of wires from Thermo-Haake (0.02, 0.03, 0.06, 0.12, 0.25, 0.50 and 1 mm) was used
³The capillary break time was determined from the time dependence of filament mid-diameter (i.e. where the diameter is close to zero) from at least 3 measurements. For a series of images recorded with frame rates typically from 10,000 to 30,000 frames per second, the mid-filament diameter was measured using specially designed image analysis software (Edgehog, developed in Prof. C H. Clasen lab, KU Leuven, Belgium).
⁴Thermal conductivity measured according to ASTM D7896 at 30° C.
⁵Includes 0.6 wt % of a dispersant additive package

As the results show, non-aqueous thermal fluids treated with low levels of high viscosity polymers show an increase in both maximum extensional viscosity and time for fluid capillary break.

Fluid mixtures of the present invention may also be evaluated to determine flash point and their ability to absorb and disperse heat. For example, additional testing of fluids of the present invention may include flash point (ASTM D92), heat capacity at 40° C. via differential scanning calorimetry (DSC), thermal conductivity at 50° C. (ASTM D7896), and dielectric strength (ASTM D1816).

Samples may also be tested to determine the forced convective heat transfer coefficient “h,” of a sample fluid through a pipe having a specified wall area (“A_{wall}”). Higher heat transfer coefficients may be used to determine whether one fluid performs better than another. This testing may include pumping a sample fluid through a pipe with a constant Pump Power. The temperature of the fluid at the pipe inlet is controlled by heat exchanger to a set inlet temperature, such as 35 degrees Celsius. The pipe wall may be heated with a direct current power supply providing constant power (“P”). The wall temperature (“T_{wall}”) may be measured using a thermocouple. A thermocouple is placed in the fluid flow and co-located near the point of the wall temperature measurement to measure the fluid temperature (“T_{fluid}”). After steady-state is reached, data is collected and averaged over 60 seconds. The forced convective heat transfer coefficient is calculated with Equation X.

q″=h*(T_{wall}−T_{fluid}) Equation X

In Equation X, q″ is the heat flux calculated from the power supply input as well as the heated area of the pipe according to Equation Y.

### Equation Y

Each of q″=P/A_{wall} the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A method of cooling electrical componentry comprising contacting the electrical componentry with a dielectric oleaginous heat transfer fluid, wherein the dielectric oleaginous heat transfer fluid comprises (a) a non-conductive, non-aqueous and non-water miscible oil component and (b) 0.001 to 1% by weight of a polymer additive component measured on an oil free basis, wherein the polymer additive component comprises or consists of one or more polyolefin polymers having a number average molecular weight (by gel permeation chromatography, polystyrene standard) of at least about 20,000; and operating the electrical componentry.

2. The method of claim 1, wherein the electrical componentry comprises a battery.

3. (canceled)

4. (canceled)

5. The method of claim 1, wherein the dielectric oleaginous heat transfer fluid has a dielectric constant of 3.0 or lower as measured according to ASTM D924.

6. The method of claim 1, wherein the non-water miscible oil component comprises a hydrocarbon.

7. The method of claim 6, wherein the hydrocarbon comprises isoparaffinic oil containing at least one saturated hydrocarbon compound having from κ to 50 carbon atoms.

8. The method of claim 7, wherein the at least one saturated hydrocarbon compound contains at least 10 carbon atoms and at least one hydrocarbyl branch and has a single continuous carbon chain of no more than 24 carbon atoms.

9. The method of claim 7, wherein the at least one saturated hydrocarbon compound comprises a branched acyclic compound with a molecular weight of 140 g/mol to 550 g/mol.

10. The method of claim 1, wherein the non-water miscible hydrocarbon oil component comprises alkylene oxide polymers and interpolymers and derivative thereof wherein the terminal hydroxyl groups have been modified by esterification or etherification.

11. The method of claim 1, wherein the one or more polyolefin polymers have a number average molecular weight (by gel permeation chromatography, poly styrene standard) of 20,000 to 10,000,000.

12. The method of claim 1, wherein the one or more polyolefin polymers comprises or consists of a polyisobutylene polymer having a number average molecular weight (by gel permeation chromatography, polystyrene standard) of at least about 50,000 as measured by gel permeation chromatography.

13. (canceled)

14. (canceled)

15. The method of claim 1, wherein the dielectric oleaginous heat transfer fluid comprises no more than 800 ppm of the polymer additive component.

16. (canceled)

17. A coolant system for an electric vehicle comprising a battery pack in contact with a dielectric oleaginous heat transfer fluid, wherein the dielectric oleaginous heat transfer fluid comprises (a) a non-conductive, non-aqueous and non-water miscible oil component and (b) 0.001 to 1%, or 0.003 to 0.8%, or 0.005 to 0.5%, or 0.01 to 0.1%, or 0.02% to 0.05% by weight of a polymer additive component, wherein the polymer additive component comprises or consists of one or more polyolefin polymers having a number average molecular weight (by gel permeation chromatography, polystyrene standard) of at least about 20,000.

18. The coolant system of claim 17, wherein the coolant system is an immersion coolant system wherein the battery pack is in fluid communication with a heat transfer fluid reservoir comprising the dielectric oleaginous heat transfer fluid.

19. The coolant system of claim 17, wherein the dielectric oleaginous heat transfer fluid has a dielectric constant of 3.0 or lower as measured according to ASTM D924.

20. The coolant system of claim 17, wherein the non-water miscible oil component comprises a hydrocarbon.

21. The coolant system of claim 20, wherein the hydrocarbon comprises isoparaffinic oil containing at least one saturated hydrocarbon compound having from 8 to 50 carbon atoms.

22. The coolant system of claim 21, wherein the at least one saturated hydrocarbon compound contains at least 10 carbon atoms and at least one hydrocarbyl branch and has a single continuous carbon chain of no more than 24 carbon atoms.

23. The coolant system of claim 22, wherein the at least one saturated hydrocarbon compound comprises a branched acyclic compound with a molecular weight of 140 g/mol to 550 g/mol.

24. The coolant system of claim 17, wherein the non-water miscible hydrocarbon oil component comprises alkylene oxide polymers and interpolymers and derivative thereof wherein the terminal hydroxyl groups have been modified by esterification or etherification.

25. The coolant system claim 17, wherein the one or more polyolefin polymers have a number average molecular weight (by gel permeation chromatography, polystyrene standard) of 20,000 to 10,000,000.

26. The coolant system claim 17, wherein the one or more polyolefin polymers comprise or consist of a polyisobutylene polymer having a number average molecular weight (by gel permeation chromatography, polystyrene standard) of at least about 50,000 as measured by gel permeation chromatography.

27. (canceled)

28. (canceled)

29. The coolant system of any of claims 17 to 28, wherein the dielectric oleaginous heat transfer fluid comprises no more than 800 ppm of the polymer additive component.

30. The coolant system claim 17, wherein the dielectric oleaginous heat transfer fluid comprises 10 ppm to 50 ppm of the polymer additive component.

31. A dielectric oleaginous heat transfer fluid comprising (a) a non-conductive, nonaqueous and non-water miscible oil component and (b) 0.001 to 1% by weight of a polymer additive component, wherein the polymer additive component comprises or consists of one or more polyolefin polymer having a number average molecular weight (by gel permeation chromatography, polystyrene standard) of at least about 20,000.

32. The dielectric oleaginous heat transfer fluid of claim 31, wherein the dielectric oleaginous heat transfer fluid has a dielectric constant of 3.0 or lower as measured according to ASTM D924.

33. The dielectric oleaginous heat transfer fluid of claim 31, wherein the non-water oil component comprises a hydrocarbon.

34. The dielectric oleaginous heat transfer fluid of claim 33, wherein the hydrocarbon comprises isoparaffinic oil containing at least one saturated hydrocarbon compound having from 8 to 50 carbon atoms.

35. The dielectric oleaginous heat transfer fluid of claim 34, wherein the at least one saturated hydrocarbon compound contains at least 10 carbon atoms and at least one hydrocarbyl branch and has a single continuous carbon chain of no more than 24 carbon atoms.

36. The dielectric oleaginous heat transfer fluid of claim 35, wherein the at least one saturated hydrocarbon compound comprises a branched acyclic compound with a molecular weight of 140 g/mol to 550 g/mol.

37. The dielectric oleaginous heat transfer fluid of claim 31, wherein the non-water miscible hydrocarbon oil component comprises alkylene oxide polymers and interpolymers and derivative thereof wherein the terminal hydroxyl groups have been modified by esterification or etherification.

38. The dielectric oleaginous heat transfer fluid of claim 31, wherein the one or more polyolefin polymers has a number average molecular weight (by gel permeation chromatography, polystyrene standard) of 20,000 to 10,000,000.

39. The dielectric oleaginous heat transfer fluid of claim 31, wherein the one or more polyolefin polymers comprises or consists of a polyisobutylene polymer having a number average molecular weight (by gel permeation chromatography, polystyrene standard) of at least about 50,000 as measured by gel permeation chromatography.

40. (canceled)

41. (canceled)

42. The dielectric oleaginous heat transfer fluid of claim 31, wherein the dielectric oleaginous heat transfer fluid comprises no more than 800 ppm of the polymer additive component.

43. The dielectric oleaginous heat transfer fluid of claim 31, wherein the dielectric oleaginous heat transfer fluid comprises 10 ppm to 50 ppm or 20 to 40 ppm of the polymer additive component.

44. (canceled)
